(19) United States
(12) Patent Application Publication
(10) Pub. No.: US 2021/0206077 A1
(43) Pub. Date: Jul. 8, 2021

(54) LID OF A BUILD MATERIAL CARRIAGE OF A THREE-DIMENSIONAL (3D) PRINTER

(71) Applicant: HEWLETT-PACKARD DEVELOPMENT COMPANY, L.P., Spring, TX (US)

(72) Inventors: Mike RODE, Vancouver, WA (US); Brent EWALD, Vancouver, WA (US); John GEILE, Vancouver, WA (US); Daniil POPOV, Vancouver, WA (US); Tristan DUDIK, Vancouver, WA (US)

(73) Assignee: HEWLETT-PACKARD DEVELOPMENT COMPANY, L.P., Houston, TX (US)

(21) Appl. No.: 16/075,616

(22) PCT Filed: Jul. 27, 2017
(86) PCT No.: PCT/US2017/044145

§ 371 Date: Aug. 4, 2018

(51) Int. Cl. B29C 64/255; B33Y 30/00; B29C 64/205; B22F 12/50; B28B 1/00

(52) U.S. Cl. CPC B29C 64/255; B33Y 30/00; B28B 1/001; B22F 12/50; B29C 64/205

(57) ABSTRACT

In some examples, a lid of a build material carriage of a three-dimensional (3D) printer can include a lid covering an opening of the build material carriage while the lid is in an engaged position, and a mechanism to keep the lid over the opening of the build material carriage while the lid is in the engaged position, where the lid uncovers the opening of the build material carriage when the build material carriage is moved to receive build material via the opening during a build material fill process such that the lid is in a disengaged position.

### BACKGROUND

A three-dimensional (3D) printer may be used to create different 3D objects. 3D printers may utilize additive manufacturing techniques to create 3D objects. For instance, a 3D printer may deposit material in successive layers in a build area of the 3D printer to create a 3D object. The material can be selectively fused, or otherwise solidified, to form the successive layers of the 3D object.

### BRIEF DESCRIPTION OF THE DRAWINGS

FIG. 1 illustrates an isometric view of an example of a build material carriage of a 3D printer consistent with the disclosure.

FIG. 2 illustrates a side view of an example of a build material carriage movement sequence consistent with the disclosure.

FIG. 3 illustrates an isometric view of an example of a build material carriage of a 3D printer consistent with the disclosure.

FIG. 4 illustrates a side view of an example of a build material carriage movement sequence consistent with the disclosure.

FIG. 5 illustrates an isometric view of an example of a build material carriage of a 3D printer consistent with the disclosure.

FIG. 6 illustrates a side view of an example of a build material carriage movement sequence consistent with the disclosure.

FIG. 7 illustrates an isometric view of an example of a build material carriage of a 3D printer consistent with the disclosure.

FIG. 8 illustrates a side view of an example of a build material carriage movement sequence consistent with the disclosure.

FIG. 9 illustrates an isometric view of an example of a build material carriage of a 3D printer consistent with the disclosure.

FIG. 10 illustrates a &de view of an example of a build material carriage movement sequence consistent with the disclosure.

FIG. 11 illustrates an example of a method of a lid of a build material carriage of a 3D printer material consistent with the disclosure.

### DETAILED DESCRIPTION

Some 3D printers can utilize a build material that has a powdered and/or granular form. The 3D printer may apply build material in successive layers in a build area to create 3D objects. The build material can be fused, and a next successive layer of build material may be applied to the build area.

As used herein, the term “3D printer” can, for example, refer to a device that can create a physical 3D object. In some examples, the 3D printer can create the 3D object utilizing a 3D digital model. The 3D printer can create the 3D object by, for example, depositing a build material such as powder, and a fusing agent, in a build area of the 3D printer. The build material may be deposited in successive layers on a build platform located in the build area to create the 3D object. In some examples, a 3D printer can create the 3D object utilizing powder bed fusion, among other types of 3D printing. For example, a 3D printer can utilize powder bed fusion by combining a fusing agent with the build material such that the fusing agent absorbs heat from a heat source in order to melt, fuse, and solidify the build material in order to create a 3D object.

Build material of the 3D printer may be transported from a storage area to the build area of the 3D printer. However, a quantity of build material may disperse into the air within the 3D printer while being transported to the build area of the 3D printer. Dispersed build material may deposit onto other parts of the 3D printer, which may cause premature wear and/or malfunctions of parts of the 3D printer.

A lid of a build material carriage of a 3D printer can cover the build material carriage, preventing build material from dispersing while being transported to the build area of the 3D printer. For instance, covering the build material carriage can prevent build material from escaping the build material carriage while the build material carriage is in transit in the 3D printer.

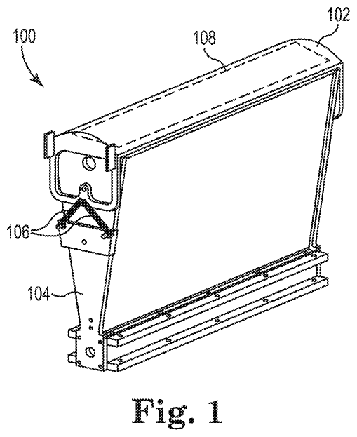

FIG. 1 illustrates an isometric view 100 of an example of a build material carriage of a 3D printer consistent with the disclosure. The build material carriage 104 may include a lid 102, spring 106, and opening 108.

As used herein, the term “build material carriage” can, for example, refer to a structure that can transport build material of a 3D printer from a first location in the 3D printer to a second location in the 3D printer. In other words, build material carriage 104 can transport build material of a 3D printer to locations in the 3D printer, such as a build area.

As used herein, the term “build material” can refer to a material used to create 3D objects in the 3D printer. Build material can be, for example, a powdered semi-crystalline thermoplastic material, a powdered metal material, a powdered plastic material, a powdered composite material, a powdered ceramic material, a powdered glass material, a powdered resin material, a short fiber material, and/or a powdered polymer material, among other types of powdered, powder-type, or particulate material.

Build material carriage 104 can include lid 102. As used herein, the term “lid” can, for example, refer to a cover to close, or substantially close, an opening. In other words, lid 102 can cover opening 108 of build material carriage 104.

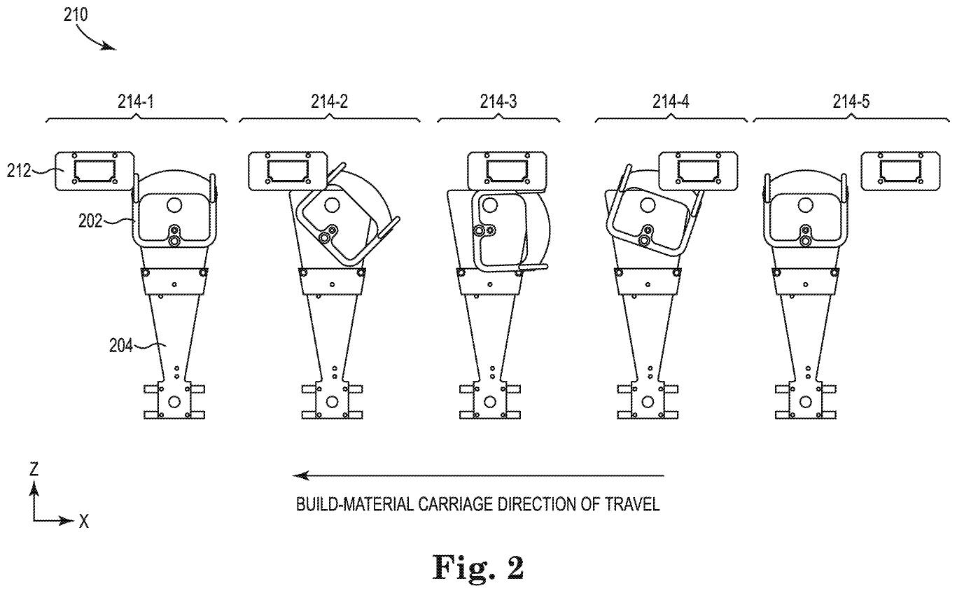

Lid 102 can cover opening 108 of build material carriage 104 while lid 102 is in an engaged position. In other words, lid 102 covers opening 108 while lid 102 is in the engaged position. Opening 108 can be uncovered when lid 102 is in a disengaged position, as is further described in connection with FIG. 2.

Lid 102 can be adjacent to opening 108. For example, as illustrated in FIG. 1, lid 102 can be covering opening 108 as a result of lid 102 being adjacent to opening 108. Opening 108 is illustrated as a dotted line in FIG. 1 as a result of lid 102 covering opening 108.

Build material carriage 104 can include a mechanism to keep lid 102 over opening 108 of build material carriage 104 while lid 102 is in the engaged position. The mechanism can include, for example, a spring, an elastic band, a counter-weight, among other types of mechanisms to keep lid 102 over opening 108 of build material carriage 104 while lid 102 is in the engaged position. For example, build material carriage 104 can include springs 106 to keep lid 102 over opening 108 of build material carriage 104 while lid 102 is in the engaged position. As used herein, the term “spring” can, for example, refer to an object used to store mechanical energy. As illustrated in FIG. 1, springs 106 can be in a resting position.

Lid 102 can uncover opening 108 when build material carriage 104 is moved to receive build material via opening 108 during a build material fill process such that lid 102 is in a disengaged position. For example, when build material carriage 104 is being filled with build material, lid 102 can be in a disengaged position such that opening 108 is exposed to a build material filling system.

Build material carriage 104 can receive build material from the build material filling system. The build material filling system may be located above build material carriage 104. For example, build material carriage 104 may receive build material from a build material filling system via a gravity drop from the build material filling system to build material carriage 104.

Springs 106 can provide a reaction force to rotate lid 102 to the engaged position from the disengaged position. As used herein, the term “reaction force” can, for example, refer to an opposing force generated in response to a stretching or compressing of a spring from its resting position, where the reaction force may be proportional to the change in length of the spring. For example, build material carriage 104 can be filled with build material when lid 102 is exposed to the build material filling system as a result of lid 102 being in a disengaged position, as is further described in connection with FIG. 2. While lid 102 is in the disengaged position, springs 106 may be stretched and/or compressed. Springs 106 can provide the reaction force to rotate lid 102 to the engaged position from the disengaged position after build material carriage 104 is filled with build material.

Lid 102 can provide a seal around opening 108 to prevent received build material from dispersing outside build material carriage 104. As described above, build material carriage 104 can transport build material of a 3D printer from a first location to a second location. Build material located in build material carriage 104 can be prevented from escaping from build material carriage 104 by lid 102. For example, acceleration and/or deceleration forces induced by movement of build material carriage 104 may cause the build material located in build material carriage 104 to move around. Lid 102 can prevent the build material located in build material carriage 104 from being dispersed in the 3D printer as a result of acceleration and/or deceleration forces while build material carriage 104 is in transit.

FIG. 2 illustrates a side view of an example of a build material carriage movement sequence 210 consistent with the disclosure. The build material carriage movement sequence 210 can include lid 202, build material carriage 204, and stationary lid opener 212.

As illustrated in FIG. 2, the side view of the movement sequence can be oriented in an x-z coordinate plane. For example, the x coordinate as shown in FIG. 2 can be a length and the z coordinate as shown in FIG. 2 can be a height,

As illustrated in FIG. 2, build material carriage 204 can include rotating lid 202. Rotating lid 202 can cover an opening of build material carriage 204 while rotating lid 202 is in an engaged position.

Rotating lid 202 can be a symmetrically rotating lid. For example, symmetrically rotating lid 202 can rotate in two directions relative to build material carriage 204. For instance, symmetrically rotating lid 202 can rotate in a clockwise direction as oriented in FIG. 2 per the direction of movement of build material carriage 204 as illustrated in FIG. 2, as is further described herein, or in a counter-clockwise direction per the opposite direction of movement of build material carriage 204 as illustrated in FIG. 2.

Although not shown in FIG. 2 for clarity and so as not to obscure examples of the disclosure, build material carriage 204 can include a spring (illustrated in FIG. 1) to keep symmetrically rotating lid 202 covering the opening of build material carriage 204 while symmetrically rotating lid 202 is in an engaged position.

Symmetrically rotating lid 202 can be rotated to a disengaged position from the engaged position in response to symmetrically rotating lid 202 contacting stationary lid opener 212 to uncover the opening of build material carriage 204 when build material carriage 204 is moved from a first position to a second position such that build material carriage 204 can receive build material via the opening. For example, as illustrated in FIG. 2, build material carriage 204 can undergo a build material carriage movement sequence 210. Build material carriage movement sequence 210 can be characterized by sequences of movement 214, as is further described herein.

As illustrated in FIG. 2, build material carriage movement sequence 210 can begin at sequence of movement 214-1. Build material carriage 204 can be at the first position at sequence 214-1, where symmetrically rotating lid 202 is in an engaged position to cover the opening of build material carriage 204.

Build material carriage 204 can begin a build material fill process by moving in a “negative” x direction at sequence 214-2 as illustrated in FIG. 2. At sequence 214-2, symmetrically rotating lid 202 can contact stationary lid opener 212 and begin to rotate, partially exposing the opening of build material carriage 204. As a result of the partially exposed opening of build material carriage 204, build material may begin to be deposited into build material carriage 204.

The build material may be deposited into build material carriage 204 via a build material filling system. The build material filling system may be located above build material carriage 204. For example, build material carriage 204 may receive build material from a build material filling system via a gravity drop from the build material filling system to build material carriage 204.

At sequence 214-3, symmetrically rotating lid 202 may be in the disengaged position as build material carriage 204 continues to move in the “negative” x direction such that the opening of build material carriage 204 is fully exposed to the build material filling system as a result of contact with stationary lid opener 212. Build material carriage 204 can be in the second position at sequence 214-3. Build material may be continuously deposited into build material carriage 204.

At sequence 214-4, build material carriage 204 continues to move in the “negative” x direction such that symmetrically rotating lid 202 begins to return to the engaged position. The opening of build material carriage 204 may be partially exposed as a result of symmetrically rotating lid 202 beginning to return to the engaged position.

At sequence 214-5, build material carriage 204 continues to move in the “negative” x direction such that symmetrically rotating lid 202 returns to the engaged position. The opening of build material carriage 204 may be covered by symmetrically rotating lid 202 at sequence 214-5. As a result of the opening of build material carriage 204 being covered, the build material fill process may be stopped. The position of build material carriage 204 can be a position similar to the first position of build material carriage 204 at sequence 214-1 such that, while on the opposite side of stationary lid opener 212, symmetrically rotating lid 202 is again in the engaged position covering the opening of build material carriage 204.

Symmetrically rotating lid 202 can be moved to the engaged position by the spring in response to the build material fill process being completed. For example, as previously described in connection with FIG. 1, the spring can provide a reaction force on symmetrically rotating lid 202 to rotate symmetrically rotating lid 202 to the engaged position from the disengaged position. Although not shown in FIG. 2, build material carriage 204 can include a dampening component at the pivot point of symmetrically rotating lid 202 to dampen the rotation of the lid from the disengaged position to the engaged position.

At sequence 214-5, build material carriage 204 can deposit the received build material from build material carriage 204 to a build area of the 3D printer. For example, the build material may be deposited to the build area as a layer of build material. Successive layers of build material can be utilized to create 3D objects with the 3D printer.

Lid of a build material carriage of a 3D printer, according to the disclosure, can allow for build material to be transported from a storage area of the 3D printer to the build area of the 3D printer without build material dispersing while in transit. The lid can keep the build material in the build material carriage while the build material carriage transports the build material to the build area of the 3D printer, preventing build material from being unintentionally deposited onto other parts of the 3D printer, which may avoid premature wear and/or other malfunctions of the 3D printer.

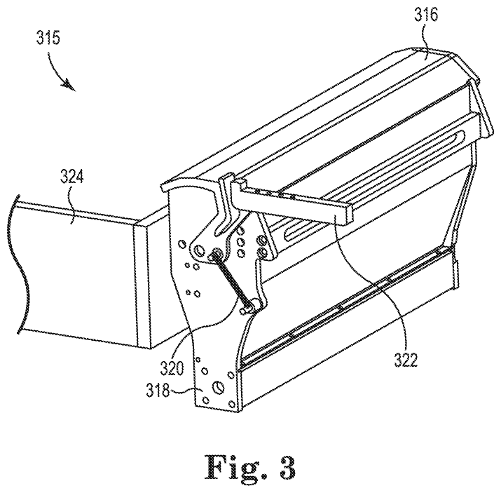

FIG. 3 illustrates an isometric view 315 of an example of a build material carriage of a 3D printer consistent with the disclosure. The build material carriage 318 may include a lid 316 and a spring 320.

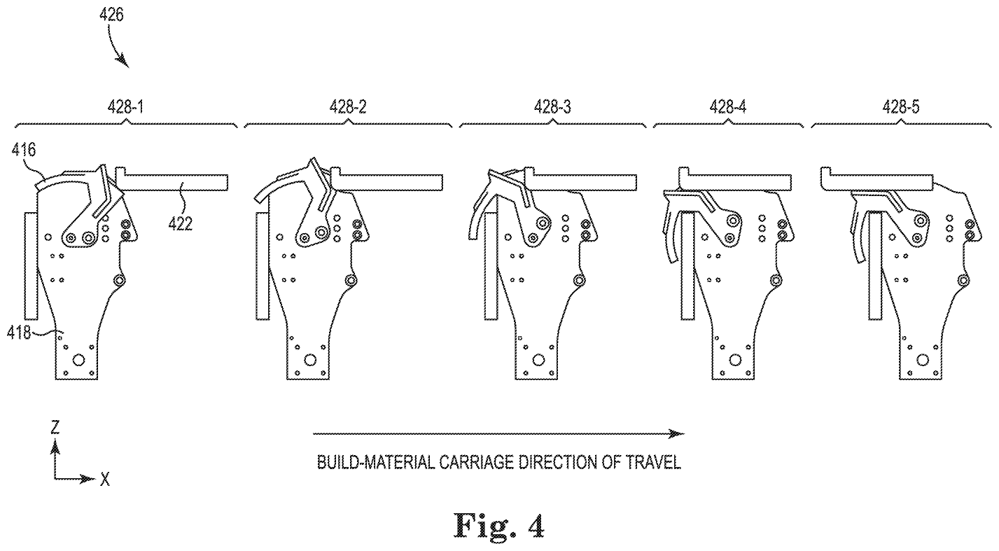

Lid 316 can be an asymmetric rotating lid. For example, asymmetric rotating lid 316 can rotate in one direction as a result of contacting stationary lid opener 322, as is further described in connection with FIG. 4.

Build material carriage 318 can include spring 320. Spring 320 can keep asymmetric rotating lid 316 over an opening (not shown) of build material carriage 318 while asymmetric rotating lid 316 is in the engaged position. Asymmetric rotating lid 316 can rotate to uncover the opening when build material carriage 318 is moved to receive build material via the opening during a build material fill process, as is further described in connection with FIG. 4. Spring 320 can provide a reaction force to rotate asymmetric rotating lid 316 to the engaged position from the disengaged position following the build material fill process.

As illustrated in FIG. 3, build material carriage 318 can move towards build area 324. Following the build material fill process, build material carriage 318 can deposit build material onto build area 324.

FIG. 4 illustrates a side view of an example of a build material carriage movement sequence 428 consistent with the disclosure. The build material carriage movement sequence 426 can include asymmetric rotating lid 416, build material carriage 418, and stationary lid opener 422,

As illustrated in FIG. 4, the side view of the movement sequence 428 can be oriented in an x-z coordinate plane. For example, the x coordinate as shown in FIG. 4 can be a length and the z coordinate as shown in FIG. 4 can be a height.

As illustrated in FIG. 4, build material carriage 418 can include asymmetric rotating lid 416. Asymmetric rotating lid 416 can cover an opening of build material carriage 418 while asymmetric rotating lid 416 is in an engaged position. Asymmetric rotating lid 416 can rotate in a counter-clockwise direction as oriented in FIG. 4 per the direction of movement of build material carriage 418 as illustrated in the build material carriage movement sequence 426. Build material carriage movement sequence 426 can be characterized by sequences of movement 428, as is further described herein.

Asymmetric rotating lid 416 can be rotated to a disengaged position from the engaged position in response to asymmetric rotating lid 416 contacting stationary lid opener 422 to uncover the opening of build material carriage 418 when build material carriage 418 is moved from a first position to a second position to receive build material during a build material fill process.

As illustrated in FIG. 4, build material carriage movement sequence 426 can begin at sequence of movement 428-1. Build material carriage 418 can be at the first position at sequence 428-1, where asymmetric rotating lid 416 is in an engaged position to cover the opening of build material carriage 418.

Build material carriage 418 can begin a build material fill process by moving in a “positive” x direction at sequence 428-2 as illustrated in FIG. 4. At sequence 428-2, asymmetric rotating lid 416 can contact stationary lid opener 422 and begin to rotate, partially exposing the opening of build material carriage 418. As a result of the partially exposed opening of build material carriage 418, build material may begin to be deposited into build material carriage 418 by, for example, a build material filling system, which can be located, in some examples, above build material carriage 418. For example, build material carriage 418 may receive build material from a build material filling system via a gravity drop from the build material filling system to build material carriage 418.

At sequence 428-3, asymmetric rotating lid 416 may continue to be rotated to the disengaged position as build material carriage 418 continues to move in the “positive” x direction.

At sequence 428-4, asymmetric rotating lid 416 may be in the disengaged position as build material carriage 418 continues to move in the “positive” x direction such that the opening of build material carriage 418 is fully exposed to the build material filling system as a result of contact with stationary lid opener 422. At sequence 428-5, asymmetric rotating lid 416 may still be in the disengaged position as build material carriage 418 can continue to move in the “positive” x direction while the opening of build material carriage 418 is still fully exposed to the build material filling system.

Build material may be deposited into build material carriage 418 at sequences 428-2, 428-3, 428-4, and/or 428-5. Build material may be deposited until build material carriage 418 has received a threshold amount of build material.

Build material carriage 418 may be moved in the opposite direction of the direction of build material carriage movement sequence 426 illustrated in FIG. 4 so that asymmetric rotating lid 416 can be moved to the engaged position by the spring in response to the build material fill process being completed. That is, build material carriage movement sequence 426 can be performed in reverse so that asymmetric rotating lid 416 can move to the engaged position and build material carriage 418 can move to deposit the build material in the build area of the 3D printer.

Asymmetric rotating lid 416 can direct received build material that may be protruding from the opening of build material carriage 418 into build material carriage 418 as asymmetric rotating lid 416 is rotated from the disengaged position at sequence 428-5 to the engaged position at sequence 428-1. For example, build material that may be piled outside of the build material carriage 418 during the build material fill process can be directed back into the build material carriage 418 by asymmetric rotating lid 416 as asymmetric rotating lid 416 is rotated to the engaged position.

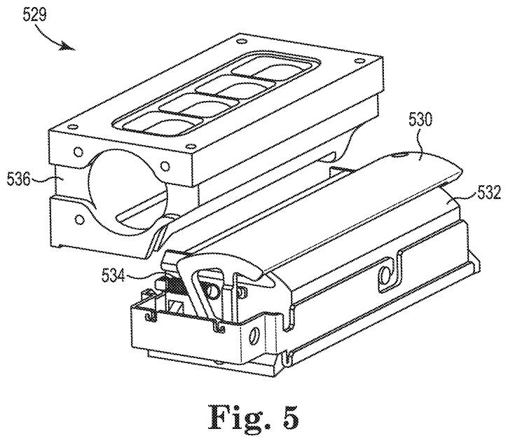

FIG. 5 illustrates an isometric view 529 of an example of a build material carriage of a 3D printer consistent with the disclosure. The build material carriage 532 may include a lid 530 and a spring 534.

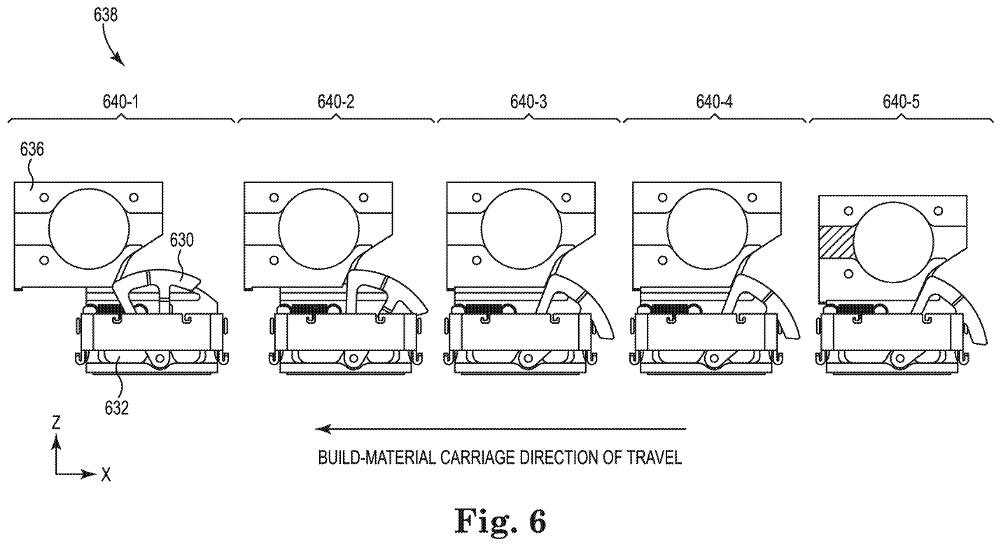

Lid 530 can be an asymmetric rotating lid. For example, asymmetric rotating lid 530 can rotate in one direction as a result of contacting cam 536, as is further described in connection with FIG. 5. As used herein, the term “cam”, can for example, refer to a sliding piece to convert linear motion into rotational motion, as is further described in connection with FIG. 6.

Build material carriage 532 can include spring 534. Spring 534 can keep asymmetric rotating lid 530 over an opening (not shown) of build material carriage 532 while asymmetric rotating lid 530 is in the engaged position. Asymmetric rotating lid 530 can rotate to uncover the opening when build material carriage 532 is moved to receive build material via the opening during a build material fill process, as is further described in connection with FIG. 6. Spring 534 can provide a reaction force to rotate asymmetric rotating lid 530 to the engaged position from the disengaged position following the build material fill process.

FIG. 6 illustrates a side view of an example of a build material carriage movement sequence 640 consistent with the disclosure. The build material carriage movement sequence 638 can include lid 630, build material carriage 632, and cam 636.

As illustrated in FIG. 6, the side view of the movement sequence 640 can be oriented in an x-z coordinate plane. For example, the x coordinate as shown in FIG. 6 can be a length and the z coordinate as shown in FIG. 6 can be a height.

As illustrated in FIG. 6, build material carriage 632 can include asymmetric rotating lid 630. Asymmetric rotating lid 630 can cover an opening of build material carriage 632 while asymmetric rotating lid 630 is in an engaged position. Asymmetric rotating lid 630 can rotate in a clockwise direction as oriented in FIG. 6 per the direction of movement of build material carriage 632 as illustrated in the build material carriage movement sequence 638. Build material carriage movement sequence 638 can be characterized by sequences of movement 640, as is further described herein.

Asymmetric rotating lid 630 can be rotated to a disengaged position from the engaged position in response to asymmetric rotating lid 630 contacting cam 636 to uncover the opening of build material carriage 632 when build material carriage 632 is moved from a first position to a second position to receive build material during a build material fill process. Asymmetric rotating lid 630 can be rotated to a first disengaged position, illustrated at sequence 640-4, and/or rotated to a second disengaged position, illustrated at sequence 640-5, as is further described herein.

As illustrated in FIG. 6, build material carriage movement sequence 638 can begin at sequence of movement 640-1. Build material carriage 632 can be at the first position at sequence 640-1, where asymmetric rotating lid 630 is in an engaged position to cover the opening of build material carriage 632.

Build material carriage 632 can begin a build material fill process by moving in a “negative” x direction at sequence at 640-2 as illustrated in FIG. 6, At sequence 640-2, asymmetric rotating lid 630 can contact cam 636 and begin to rotate, partially exposing the opening of build material carriage 632, As a result of the partially exposed opening of build material carriage 632, build material may begin to be deposited into build material carriage 632 by, for example, a build material filling system, which can be located, in some examples, above build material carriage 632. For example, build material carriage 632 may receive build material from a build material filling system via a gravity drop from the build material filling system to build material carriage 632.

Al. sequence 640-3, asymmetric rotating lid 630 may continue to be rotated to a disengaged position as build material carriage 632 continues to move in the “negative” x direction. That is, build material carriage 632 can move horizontally relative to cam 636.

At sequence 640-4, asymmetric rotating lid 630 may be in the first disengaged position as build material carriage 632. At sequence 640-4, the opening of build material carriage 632 may be substantially exposed as a result of contact with cam 636.

At sequence 640-5, cam 636 can move vertically relative to build material carriage 632. The vertical movement of cam 636 can cause asymmetric rotating lid 630 to rotate to the second disengaged position, That is, the downward movement of earn 636 at sequence 640-5 can cause asymmetric rotating lid 630 to rotate to the second disengaged position such that the opening of build material carriage 632 is fully exposed to the build material filling system. The second disengaged position can be an extended-disengaged position from the disengaged position illustrated at sequence 640-4.

Cam 636 can provide a seal around the opening of build material carriage 632, For example, as a result of the cam 636 moving vertically relative to build material carriage 632 to cause asymmetric rotating lid 630 to rotate to the second disengaged position, cam 636 can be adjacent to and/or rest on a top surface of build material carriage 632.

The build material can be received by build material carriage 632 from a build material fill system through an opening in cam 636. For example, the cam can include an opening such that the build material can be directed from the build material fill system into the build material carriage 632 through a slot in cam 636, Receiving build material through cam 636 can prevent build material from being dispersed in the 3D printer during the build material fill process.

Cam 636 and build material carriage 632 may be moved in the opposite directions of the direction of build material carriage movement sequence 638 illustrated in FIG. 6 so that asymmetric rotating lid 630 can be moved to the engaged position by the spring in response to the build material fill process being completed, That is, build material carriage movement sequence 638 can be performed in reverse so that cam 636 moves up and asymmetric rotating lid 630 can move to the engaged position and build material carriage 632 can move to deposit the build material in the build area of the 3D printer.

Asymmetric rotating lid 630 can direct received build material that may be protruding from the opening of build material carriage 632 into build material carriage 632 as asymmetric rotating lid 630 is rotated from the disengaged position at sequence 640-5 to the engaged position at sequence 640-1. For example, build material that may be piled outside of the build material carriage 632 during the build material fill process can be directed back into the build material carriage 632 by asymmetric rotating lid 630 as asymmetric rotating lid 630 is rotated to the engaged position.

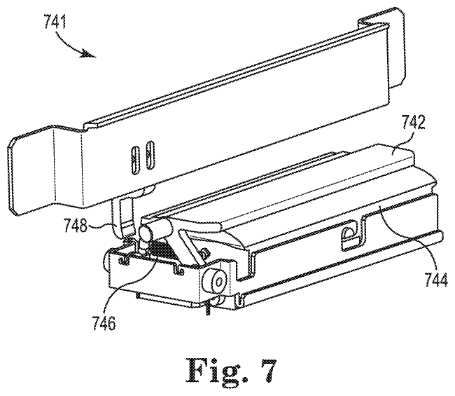

FIG. 7 illustrates an isometric view 741 of an example of a build material carriage of a 3D printer consistent with the disclosure. The build material carriage 744 may include a lid 742 and a spring 746.

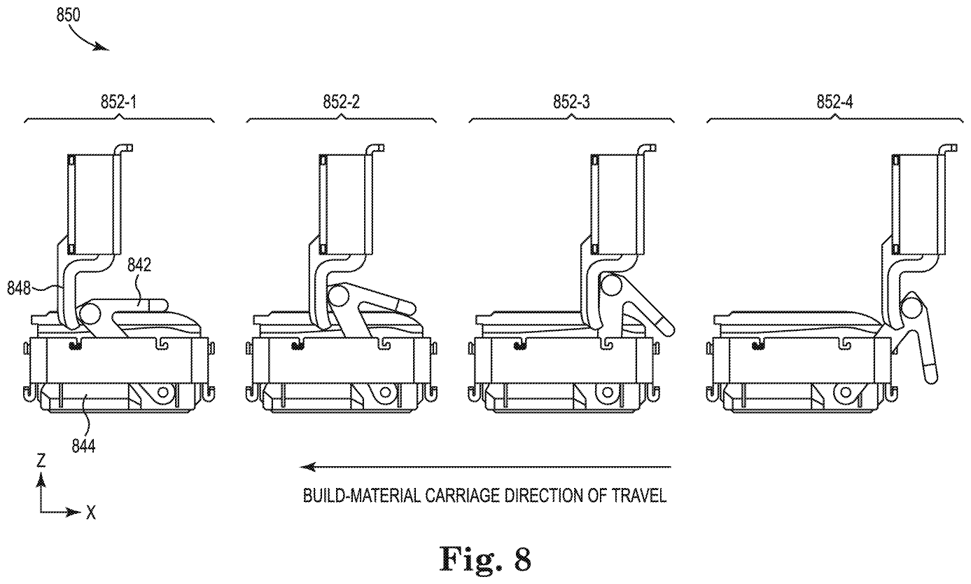

Lid 742 can be an asymmetric rotating lid. For example, asymmetric rotating lid 742 can rotate in one direction as a result of contacting stationary lid opener 748, as is further described in connection with FIG. 8.

Build material carriage 744 can include spring 746. Spring 746 can keep asymmetric rotating lid 742 over an opening (not shown) of build material carriage 744 while asymmetric rotating lid 742 is in the engaged position. Asymmetric rotating lid 742 can rotate to uncover the opening when build material carriage 744 is moved to receive build material via the opening during a build material fill process, as is further described in connection with FIG. 8. Spring 746 can provide a reaction force to rotate asymmetric rotating lid 742 to the engaged position from the disengaged position following the build material fill process

FIG. 8 illustrates a side view of an example of a build material carriage movement sequence 852 consistent with the disclosure. The build material carriage movement sequence 850 can include lid 842, build material carriage 844, and stationary lid opener 848.

As illustrated in FIG. 8, the side view of the movement sequence 852 can be oriented in an x-z coordinate plane. For example, the x coordinate as shown in FIG. 8 can be a length and the z coordinate as shown in FIG. 8 can be a height.

As illustrated in FIG. 8, build material carriage 844 can include asymmetric rotating lid 842. Asymmetric rotating lid 842 can cover an opening of build material carriage 844 while asymmetric rotating lid 842 is in an engaged position. Asymmetric rotating lid 842 can rotate in a clockwise direction as oriented in FIG. 8 per the direction of movement of build material carriage 844 as illustrated in the build material carriage movement sequence 850. Build material carriage movement sequence 850 can be characterized by sequences of movement 852, as is further described herein.

Asymmetric rotating lid 842 can be rotated to a disengaged position from the engaged position in response to asymmetric rotating lid 842 contacting stationary lid opener 848 to uncover the opening of build material carriage 844 when build material carriage 844 is moved from a first position to a second position to receive build material during a build material fill process.

As illustrated in FIG. 8, build material carriage movement sequence 850 can begin at sequence of movement 852-1. Build material carriage 844 can be at the first position at sequence 852-1, where asymmetric rotating lid 842 is in an engaged position to cover the opening of build material carriage 844.

Build material carriage 844 can begin a build material fill process by moving in a “negative” x direction at sequence 852-2 as illustrated in FIG. 8. At sequence 852-2, asymmetric rotating lid 842 can contact stationary lid opener 848 and begin to rotate, partially exposing the opening of build material carriage 844. As a result of the partially exposed opening of build material carriage 844, build material may begin to be deposited into build material carriage 844 by, for example, a build material filling system, which can be located, in some examples, above build material carriage 844. For example, build material carriage 844 may receive build material from a build material filling system via a gravity drop from the build material filling system to build material carriage 844.

At sequence 852-3, asymmetric rotating lid 842 may continue to be rotated to the disengaged position as build material carriage 844 continues to move in the “negative” x direction.

At sequence 852-4, asymmetric rotating lid 842 may be in the disengaged position as build material carriage 844 continues to move in the “negative” x direction such that the opening of build material carriage 844 is fully exposed to the build material filling system as a result of contact with stationary lid opener 848.

Build material may be continuously deposited into build material carriage 844 at sequences 852-2, 852-3, and/or 852-4. Build material may be deposited until build material carriage 844 has received a threshold amount of build material.

Build material carriage 844 may be moved in the opposite direction of the direction of build material carriage movement sequence 850 illustrated in FIG. 8 so that asymmetric rotating lid 842 can be moved to the engaged position by the spring in response to the build material fill process being completed. That is, build material carriage movement sequence 850 can be performed in reverse so that asymmetric rotating lid 842 can move to the engaged position and build material carriage 844 can move to deposit the build material in the build area of the 3D printer.

Asymmetric rotating lid 842 can be rotated to the engaged position when build material carriage 844 is moved from the second position, illustrated at sequence 852-4, to the first position, illustrated at sequence 852-1, such that asymmetric rotating lid 842 returns to the engaged position in a downward direction relative to build material carriage 844. By returning to the engaged position in a downward direction, asymmetric rotating lid 842 can direct received build material that may be protruding from the opening of build material carriage 844 into build material carriage 844. The downward direction of rotation of asymmetric rotating lid 842 can direct any protruding build material into build material carriage 844 in a downward direction instead of “scraping” protruding build material in an example in which a rotating lid is returned to the engaged position in a more horizontal manner.

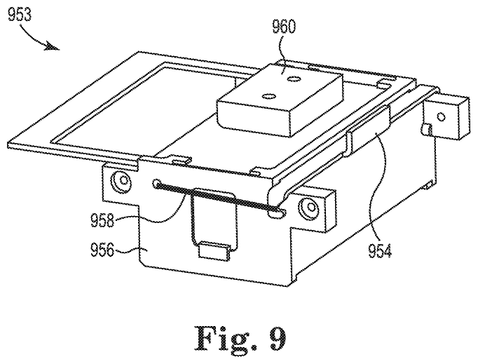

FIG. 9 illustrates an isometric view 953 of an example of a build material carriage of a 3D printer consistent with the disclosure. The build material carriage 956 may include a lid 954 and a spring 958.

Lid 954 can be a sliding lid. For example sliding lid 954 can slide in two directions relative to build material carriage 956 as a result of contacting stationary lid opener 960.

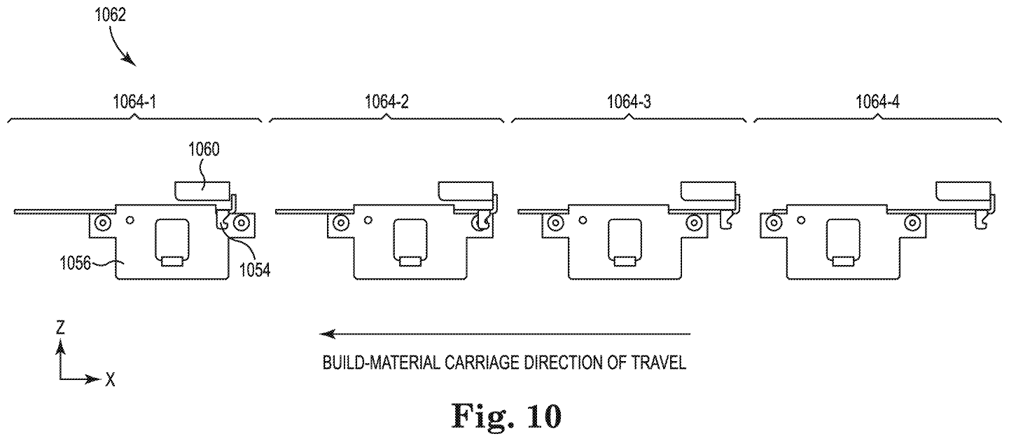

Build material carriage 956 can include spring 958. Spring 958 can keep sliding lid 954 over an opening (not shown) of build material carriage 956 while sliding lid 954 is in the engaged position. Sliding lid 954 can slide to uncover the opening when build material carriage 956 is moved to receive build material via the opening during a build material fill process, as is further described in connection with FIG. 10. Spring 958 can provide a reaction force to slide sliding lid 954 to the engaged position from the disengaged position following the build material fill process.

Although shown in FIG. 9 as including one spring 958, examples of the disclosure are not so limited. For example, build material carriage 956 can include a second spring that can be on an opposite side of build material carriage 956, Spring 958 and the spring on the opposite side (not shown) can provide a substantially uniform reaction force to slide sliding lid 954 to the engaged position from the disengaged position following the build material fill process.

FIG. 10 illustrates a side view of an example of a build material carriage movement sequence 1064 consistent with the disclosure. The build material carriage movement sequence 1064 can include lid 1054, build material carriage 1056, and stationary lid opener 1060.

As illustrated in FIG. 10, the side view of the movement sequence 1064 can be oriented in an x-z coordinate plane. For example, the x coordinate as shown in FIG. 10 can be a length and the z coordinate as shown in FIG. 10 can be a height.

As illustrated in FIG. 10, build material carriage 1056 can include sliding lid 1054. Sliding lid 1054 can cover an opening of build material carriage 1056 while sliding lid 1054 is in an engaged position. Sliding lid 1054 can slide in a horizontal direction (e.g., a “positive” x direction) per the direction of movement of build material carriage 1056 as illustrated in the build material carriage movement sequence 1062. Build material carriage movement sequence 1062 can be characterized by sequences of movement 1064, as is further described herein.

Sliding lid 1054 can be slid to a disengaged position from the engaged position in response to sliding lid 1054 contacting stationary lid opener 1060 when build material carriage 1056 is moved from a first position to a second position to receive build material during a build material fill process.

As illustrated in FIG. 10, build material carriage movement sequence 1062 can begin at sequence of movement 1064-1. Build material carriage 1056 can be at the first position at sequence 1064-1, where sliding lid 1054 is in an engaged position to cover the opening of build material carriage 1056.

Build material carriage 1056 can begin a build material fill process by moving in a “negative” x direction at sequence 1064-2 as illustrated in FIG. 10. At sequence 1064-2, sliding lid 1054 can contact stationary lid opener 1060 and begin to slide, partially exposing the opening of build material carriage 1056. As a result of the partially exposed opening of build material carriage 1056, build material may begin to be deposited into build material carriage 1056 by, for example, a build material filling system, which can be located, in some examples, above build material carriage 1056, For example, build material carriage 1056 may receive build material from a build material filling system via a gravity drop from the build material filling system to build material carriage 1056.

At sequence 1064-3, sliding lid 1054 may continue to be slid to the disengaged position as build material carriage 1056 continues to move in the “negative” x direction.

At sequence 1064-4, sliding lid 1054 may be in the disengaged position as build material carriage 1056 continues to move in the “negative” x direction such that the opening of build material carriage 1056 is fully exposed to the build material filling system as a result of contact with stationary lid opener 1060.

Build material may be continuously deposited into build material carriage 1056 at sequences 1064-2, 1064-3, and/or 1064-4. Build material may be deposited until build material carriage 1056 has received a threshold amount of build material.

Build material carriage 1056 may be moved in the opposite direction of the direction of build material carriage movement sequence 1062 illustrated in FIG. 10 so that sliding lid 1054 can be moved to the engaged position by the springs in response to the build material fill process being completed. That is, build material carriage movement sequence 1062 can be performed in reverse so that sliding lid 1054 can move to the engaged position and build material carriage 1056 can move to deposit the build material in the build area of the 3D printer.

Sliding lid 1054 can direct received build material that may be protruding from the opening of build material carriage 1056 into build material carriage 1056 as sliding lid 1054 is slid from the disengaged position at sequence 1064-4 to the engaged position at sequence 1064-1. For example, build material that may be piled outside of the build material carriage 1056 during the build material fill process can be directed back into the build material carriage 1056 by sliding lid 1054 as sliding lid 1054 is slid to the engaged position.

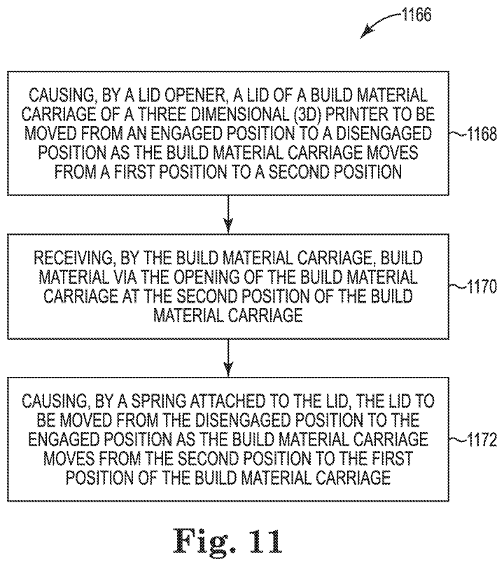

FIG. 11 illustrates an example of a method 1166 of a lid of a build material carriage of a 3D printer consistent with the disclosure. For example, method 1166 may be performed by a build material carriage, a lid of the build material carriage, a spring of the build material carriage, and a lid opener.

At 1168, the method 1166 includes causing, by a lid opener, a lid of a build material carriage of a 3D printer to be moved from an engaged position to a disengaged position as the build material carriage moves from a first position to a second position. For example, the build material carriage can move to a position to receive build material in a build material fill process. The lid of the build material carriage can be moved from the engaged position covering an opening of the build material carriage as the build material carriage moves from the first position to the disengaged position uncovering the opening of the build material carriage as the build material carriage moves to the second position. In some examples, the lid of the build material carriage can be rotated, slid, tiled, etc. from the engaged position to the disengaged position.

At 1170, the method 1166 can include receiving, by the build material carriage, build material via the opening of the build material carriage at the second position of the build material carriage. The lid of the build material carriage can be at the disengaged position at the second position of the build material carriage such that the opening of the build material carriage is uncovered at the second position. The build material carriage can receive the build material from a build material filling system, which may, in some examples, be located above the build material carriage, For example, the build material carriage may receive build material from a build material filling system via a gravity drop from the build material filling system to the build material carriage.

At 1172, the method 1166 can include causing, by a spring attached to the lid, the lid to be moved from the disengaged position to the engaged position as the build material carriage moves from the second position to the first position of the build material carriage, For example, following the build material fill process, the build material carriage can move to the first position and the lid of the build material carriage can be moved to the engaged position to cover the opening of the build material carriage. In some examples, the lid of the build material carriage can be rotated, slid, tiled, etc. from the disengaged position to the engaged position.

Method 1166 can include depositing the received build material from the build material carriage at the first position to a build area of the 3D printer. For example, build material carriage can transport build material from a storage area of the 3D printer to the build area of the 3D printer while keeping build material inside of the build material carriage via the lid. The lid can prevent build material from dispersing and unintentionally being deposited onto other parts of the 3D printer. The build material carriage can deposit the build material onto the build area of the 3D printer, where the build material can be utilized in successive layers to create 3D objects with the 3D printer.

As used herein, “logic” is an alternative or additional processing resource to perform a particular action and/or element described herein. Logic may include hardware. The hardware may include processing resources such as circuitry, which are distinct from machine readable instructions on a machine readable media. Further, as used herein, “a” thing may refer to one, or more than one of such things. For example, “a widget” may refer to one widget, or more than one widget.

The figures follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

Multiple analogous elements within one figure may be referenced with a reference numeral followed by a hyphen and another numeral or a letter. For example, 302-1 may reference element 02-1 in FIGS. 3 and 302-2 may reference element 02-2, which can be analogous to element 02-1.

The above specification, examples and data provide a description of the method and applications, and use of the system and method of the present disclosure. Since many examples may be made without departing from the spirit and scope of the system and method of the present disclosure, this specification merely sets forth some of the many possible example configurations and implementations.

What is claimed is:

1. A build material carriage of a three-dimensional (3D) printer, comprising:
a lid covering an opening of the build material carriage while the lid is in an engaged position; and
a mechanism to keep the lid over the opening of the build material carriage while the lid is in the engaged position;
wherein the lid uncovers the opening of the build material carriage when the build material carriage is moved to receive build material via the opening during a build material fill process such that the lid is in a disengaged position.

2. The build material carriage of claim 1, wherein the lid is moved to the engaged position by the mechanism in response to the build material fill process being completed.

3. The build material carriage of claim 1, wherein:
the lid is a symmetrically rotating lid; and
the symmetrically rotating lid is rotated to the disengaged position in response to the symmetrically rotating lid contacting a stationary lid opener when the build material carriage is moved to receive the build material during the build material fill process.

4. The build material carriage of claim 1, wherein:
the lid is an asymmetric rotating lid; and
the asymmetrically rotating lid is rotated to the disengaged position in response to the asymmetrically rotating lid contacting a stationary lid opener when the build material carriage is moved to receive the build material during the build material fill process.

5. The build material carriage of claim 1, wherein:
the lid is an asymmetric rotating lid; and
the asymmetrically rotating lid is rotated in response to the asymmetrically rotating lid contacting a cam, wherein the cam:
causes the asymmetrically rotating lid to rotate to a first disengaged position when the build material carriage is moved horizontally relative to the cam to receive the build material during the build material fill process; and
causes the asymmetrically rotating lid to rotate to a second disengaged position when the cam is moved vertically relative to the build material carriage.

6. The build material carriage of claim 1, wherein:
the lid is an asymmetric rotating lid; and
the asymmetrically rotating lid is rotated to the disengaged position in response to the asymmetrically rotating lid contacting a stationary lid opener when the build material carriage is moved from a first position to a second position to receive the build material during the build material fill process; and
the asymmetrically rotating lid is rotated to the engaged position when the build material carriage is moved from the second position to the first position such that the lid returns to the engaged position in a downward direction relative to the build material carriage.

7. The build material carriage of claim 1, wherein:
the lid is a sliding lid; and
the sliding lid is slid to the disengaged position in response to the sliding lid contacting a stationary lid opener when the build material carriage is moved to receive the build material during the build material fill process.

8. A three-dimensional (3D) printer, comprising:
a moveable lid covering an opening of the build material carriage while the rotating lid is in an engaged position; and
a mechanism to keep the moveable lid over the opening of the build material carriage while the moveable lid is in the engaged position;
wherein the moveable lid is moved to a disengaged position in response to the moveable lid contacting a stationary lid opener to uncover the opening of the build material carriage when the build material carriage is moved from a first position to a second position such that the build material carriage receives build material via the opening; and
wherein the moveable lid is moved to the engaged position to cover the opening of the build material carriage when the build material carriage is moved from the second position to the first position.

9. The 3D printer of claim 8, wherein the mechanism provides a reaction force to rotate the moveable lid to the engaged position when the build material carriage is moved from the second position to the first position.

10. The 3D printer of claim 8, wherein the moveable lid provides a seal around the opening to prevent the received build material from dispersing outside the build material carriage.

11. A method, comprising:
causing, by a lid opener, a lid of a build material carriage of a three-dimensional (3D) printer to be moved from an engaged position to a disengaged position as the build material carriage moves from a first position to a second position, wherein the lid covers an opening of the build material carriage in the engaged position;
receiving, by the build material carriage, build material via the opening of the build material carriage at the second position of the build material carriage;
causing, by a spring attached to the lid, the lid to be moved from the disengaged position to the engaged position as the build material carriage moves from the second position to the first position of the build material carriage.

12. The method of claim 11, wherein the method includes depositing the received build material from the build material carriage at the first position to a build area of the 3D printer.

13. The method of claim 11, wherein the method includes directing received build material protruding from the opening of the build material carriage into the build material carriage of the 3D printer as the lid is moved from the disengaged position to the engaged position.

14. The method of claim 11, wherein the method includes lowering the lid opener onto the build material carriage at the second position of the build material carriage to cause the lid to further move to an extended-disengaged position, wherein the lid opener provides a seal around the opening of the build material carriage.

15. The method of claim 14, wherein the method includes receiving the build material through a slot in the lid opener.
